(19) United States
(12) Patent Application Publication
(10) Pub. No.: US 2002/0055849 A1
(43) Pub. Date: May 9, 2002

(54) Workflow primitives modeling

(76) Inventors: Dimitrios Georgakopoulos, Austin, TX (US); Marek Rusinkiewicz, Austin, TX (US); Hans Alois Schuster, Ettlingen (DE)

Correspondence Address: DEWAN & LALLY LLP, PO BOX 684749, AUSTIN, TX, 78768, US

(21) Appl. No.: 09/895,845

(22) Filed: Jun. 29, 2001

Related U.S. Application Data
(60) Provisional application No. 60/215,437, filed on Jun. 30, 2000.

(51) Int. Cl. G06F 17/60

(52) U.S. Cl. 705/1

(57) ABSTRACT

A workflow management method and system including a process definition tool enabling a user to model a workflow process definition. A workflow management engine is configured to interpret the workflow process definition to perform workflow management tasks. The definition tool and workflow management engine are configured to support primitives including an inhibitor primitive that enables modeling processes having mutually exclusive interdependencies, an option primitive that may be instantiated zero or more times, a group assignment primitive that supports group activity, and an activity placeholder that enables the specification of activities whose concrete types may be unknown at process definition time.

This application claims priority under 35 USC § 119(e)(1) from the provisional patent application entitled, MODELING AND EXECUTION OF WORKFLOW PRIMITIVES, Ser. No. 60/215,437, filed Jun. 30, 2000.

### BACKGROUND

1. Field of the Present Invention

The present invention generally relates to the field of process or workflow modeling and automation and more particularly to workflow management software incorporating novel primitives to extend its flexibility and capability.

2. History of Related Art

A workflow is the automation of a business or organizational process during which information or tasks are passed from one participant (user or application information system/program) to another for action based on defined procedural rules. Such processes are defined by specifying the various process sub-activities, procedural rules, and corresponding data used to manage the workflow during process execution. To initiate process definition or modeling, a process model defines “types” for activities, resources, and dependencies that are provided to develop process definitions. Such definitions are instantiated by a workflow process engine enactment service during enactment. Many individual process instances may be operational during process enactment.

A process activity type typically consists of activity variables, resource variables, and dependency variables. Activity variables represent the sub-activities of a process. Resource variables describe the resources needed during process execution. These are typically data, roles that define a set of participants, and/or invoked applications. Dependency variables define the coordination rules and the order of execution for the sub-activities of the process.

In conventional workflow management systems, there are three basic types of dependency variables: 1) control flow dependencies, 2) data-flow dependencies, and 3) role assignment dependencies. Control flow dependencies impose restrictions on the occurrence and order of the activity instances within a process. Data-flow dependencies define the flow of the workflow relevant data between activities. Role assignment dependencies define the assignment of activity instances to participants.

In workflow models and systems, control flow primitives are called transitions. A control flow transition originates at exactly one activity variable and points to exactly one target activity variable. A transition implies that the activity instances belonging to the originating activity variable have to precede the activity instances of the target activity variable. Additionally, a transition condition may be attached to a transition to control the validity of the transition. When multiple transitions point to the same target activity variable, this situation is called a JOIN. Transitions in a JOIN may be combined by a transition join policy that is attached to the target activity variable. A join policy is a Boolean condition on the incoming transitions. Existing workflow management systems and standards typically support only pure AND (AND-SPLIT) or OR (OR-SPLIT) conditions.

When the control flow dependencies determine that an activity is ready to be executed, the workflow engine or server generates items that: (1) represent the activity to be performed and (2) present such a work item to each participant that plays the role assigned to the activity. Work items are presented to the participant via a worklist that maintains the details of all work items allocated to each participant. Conventional workflow management system are typically limited to supporting the coordination of repetitive workflows that can be completely defined before the start of the execution and have rigid control flow rules. Workflow Management Systems (WfMS's) are either stand-alone systems (MQSeries® Workflow from IBM Corporation and FileNet, or they are embedded in Enterprise Resource Planning (ERP) systems (e.g., SAP) and e-business Enterprise Application Integration (EAIs) infrastructures (e.g., Vitria and TIBCO). WfMS's have become a major industry and currently WfMS's capture coordination and resources utilization rules in predefined/static processes definitions that consist of prescribed activities.

### SUMMARY OF THE INVENTION

The present invention contemplates novel primitives for control flow, role assignment, and late binding of activities in a workflow management system. These primitives provide coordination flexibility and workflow runtime extensibility. In particular, these novel primitives permit support for optional and group activities, and allow the addition of these and prescribed activities during runtime. Workflow systems using these primitives will be capable of supporting applications that are currently difficult, too expensive, or impossible to support with the existing rigid control flow and role assignment primitives. Furthermore, because the disclosed primitives work seamlessly with existing workflow system primitives, this new technology can easily be combined with existing workflow technology.

Generally speaking, the present invention allows workflow management system users to model and execute the disclosed primitives to extend existing control flow dependencies, role assignment dependencies, and to permit late binding of activities. The disclosed primitives are identified as inhibitor primitives, option primitives, group assignment primitives, and placeholder or abstract activity primitives.

The inhibitor primitive allows a user to define and enforce coordination rules that are currently either unsupported or are too complex to specify and whose accuracy is difficult to verify. For example, defining a workflow process that has two or more mutually exclusive activities (i.e., if one activity is executed, then no other activity can be executed) is often complex when using an existing workflow model and management system. The disclosed inhibitor primitive simplifies the definition and verification of coordination rules.

The option primitive permits optional activities. Option primitives and optional activities are not supported by existing workflow models and systems, which support only predefined processes consisting of prescribed activities. Option primitives permit satisfying the objectives of many applications that cannot be met by simply running an algorithm in the form of a predefined process. The option primitive is useful when the potential activities to achieve the application's objective are often known, but usually the timing and frequency of their usage cannot be fully predetermined.

The option and inhibitor primitives can be combined in control flow patterns that support windows of opportunities. Defining such a pattern in a process permits the workflow system to suggest one or more optional activities to its participants at a specific point in the workflow process execution (e.g., when an activity is completed), and disallow these options at another point (e.g., when a different activity starts).

The role assignment primitive in workflow management systems determines who is doing what activity within a process. Role assignment in existing workflow management systems and other process-based systems is limited to a one-out-of-n semantics. This means that each activity instance is performed by exactly one participant out of n eligible participants that play on or more role(s) assigned to the activity in the process definition. This disclosure further introduces group assignment that allows a group of participants (i.e., m-out-of-n where m≦n) to perform the same activity. This m-out-of-n role assignment primitive grants the allocation of the same activity to more than one of the participants if m>1, or even all of the participants in a role where m=n.

The placeholder or abstract activity primitive permits late binding of activities to a running workflow. Placeholders allow the definition of abstract activities whose concrete types or implementations are known or intentionally left open at the specification time of a process. An activity placeholder primitive may be declared at any point in a process specification where a conventional concrete activity can be declared. At runtime, when activity placeholders are enabled by control flow, they may be replaced by activities with particular activity types specified in the placeholder.

Therefore, the placeholder primitive provides additional flexibility that is critical in the support of applications that require run time workflow extension and refinement. Placeholder flexibility is also beneficial in cases where the actual activities cannot be determined until the workflow execution reaches the placeholder activity.

### BRIEF DESCRIPTION OF THE DRAWINGS

Other objects and advantages of the invention will become apparent upon reading the following detailed description and upon reference to the accompanying drawings in which:

FIG. 1 is a block diagram of selected features of a workflow management system suitable for use in one embodiment of the invention;

FIG. 2A is a conceptualized block diagram illustrating an inhibitor primitive at definition time according to one embodiment of the invention;

FIG. 2B is a conceptualized block diagram illustrating an inhibitor primitive at runtime according to one embodiment of the invention;

FIG. 3A is a conceptualized block diagram illustrating an option primitive at definition time according to one embodiment of the invention;

FIG. 3B is a conceptualized block diagram illustrating an option primitive at runtime according to one embodiment of the invention;

FIG. 4A is a conceptualized block diagram illustrating a group assignment primitive at definition time according to one embodiment of the invention;

FIG. 4B is a conceptualized block diagram illustrating a group assignment primitive at runtime according to one embodiment of the invention;

FIG. 5A is a conceptualized block diagram illustrating an abstract activity primitive at definition time according to one embodiment of the invention; and

FIG. 5B is a conceptualized block diagram illustrating an activity primitive at runtime according to one embodiment of the invention.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

Generally speaking, the invention contemplates process modeling primitives and related workflow management systems that may be used to automate business or organizational processes. The invention may be implemented as a set of computer instructions (software) that resides on a computer readable medium such as a dynamic or static memory, a hard disk, floppy diskette, CD ROM, DVD, magnetic tape, or other suitable medium. When implemented in a workflow management system, the invention enables a user to construct, implement, and enact workflow process definitions using one or more dynamic and flexible workflow primitives as described in greater detail below. These primitives include an inhibitor primitive, an option primitive, a group assignment primitive, and an activity placeholder or abstract activity primitive.

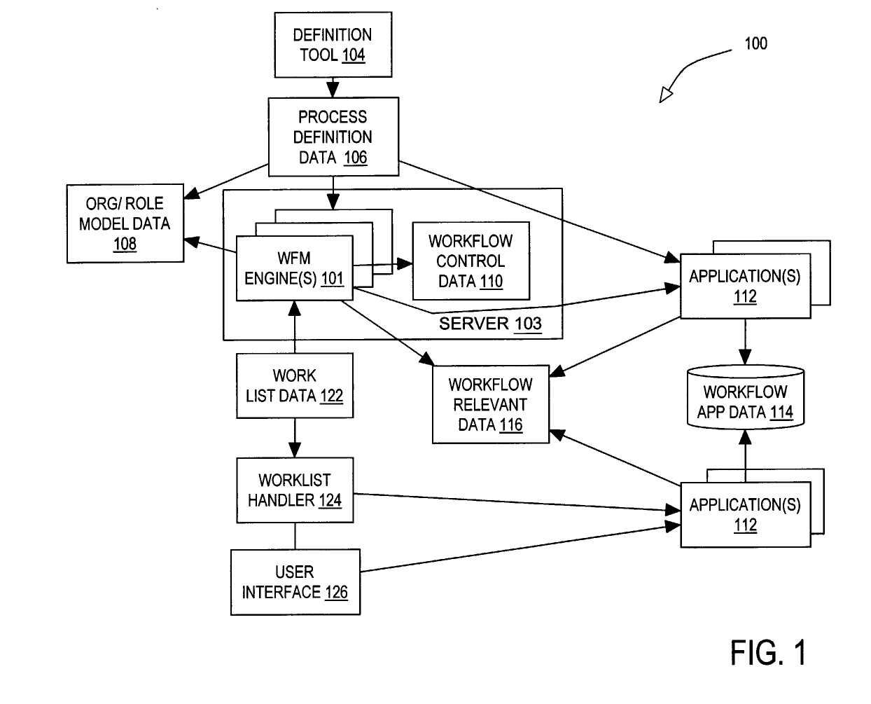

Referring now to FIG. 1, a block diagram illustrating selected features of a workflow management system (WMS) 100 according to one embodiment of the invention is depicted. In the depicted embodiment, WMS 100 is implemented according to a client-server model in which one or more clients access a workflow management engine 101 residing on a server 103. In this embodiment, the clients may represent both the software that a user invokes to access server 103 and the computer or other device on which the client software resides. The various clients may include a process design tool, a worklist handler tool, a process monitor, external applications that are integrated by server 103, all executing on a variety of a desktop, laptop, or network computers.

In the depicted embodiment, workflow management system 100 includes a process definition tool 104, a worklist handler 124, a user interface 126, and a workflow management engine 101. The process definition tool 104 enables a user to model or develop a workflow process definition 106 that is capable of being interpreted by workflow management engine 101. Process definition may reference pre-existing organization/role model data 108 as well as external application 112.

Workflow management engine(s) 101 acts on a previously specified model to perform workflow management tasks including, for example, initiating various activities, tracking their progress, assigning participants to activities, and notifying participants of selected pending or completed activity events. Engine(s) 101 maintains the workflow control data 110 using workflow relevant data 116, role model data 108, and one or more worklists 122 generated by a worklist handler 124. Engine(s) 101 may invoke applications 112 to update workflow relevant data 116 and to manipulate workflow application data 114. User interface 126 permits a user to access his or her worklist via worklist handler 124 and may also permit the user to invoke applications 112.

As described previously, traditional workflow management solutions are limited in the types of workflow processes they can model. More particularly, traditional workflow systems are optimized for use with workflow processes that can be fully defined before process execution begins. The depicted embodiment of definition tool 104 and engine 101 support one or more primitives as described herein that enable the user to define and execute flexible and dynamic workflow models not supported by conventional systems or Interface 1, 2, 3, and 4 Workflow Management standards (the Standards). The Standards are adapted by and available from the Workflow Management Coalition at www.wfmc.org and are incorporated by reference herein.

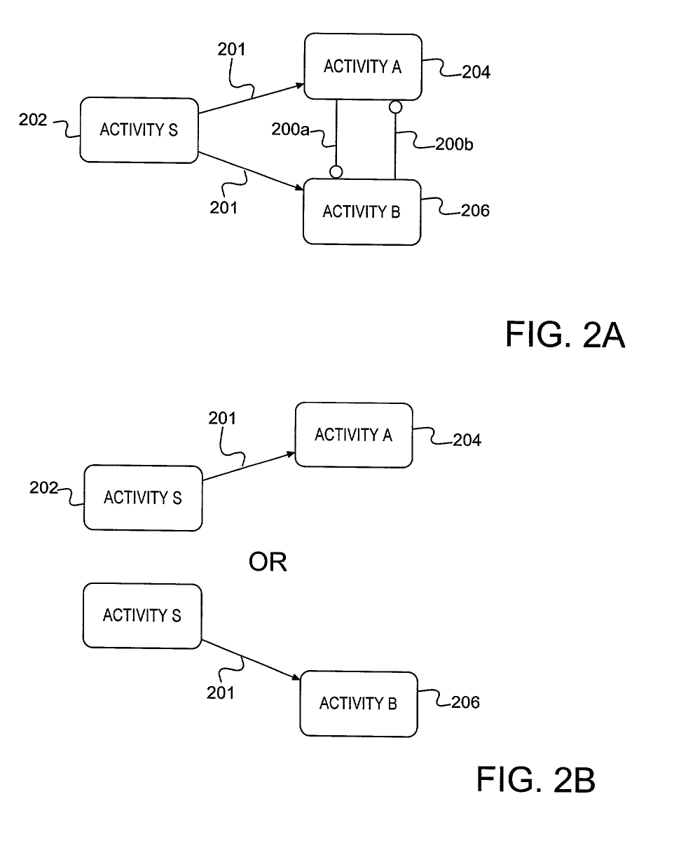

Referring now to FIGS. 2A and 2B, a conceptualized representation of a first primitive, referred to herein as an inhibitor primitive at definition time and runtime are depicted. Inhibitor primitives simplify the modeling and execution control of processes having mutually exclusive execution interdependencies. Inhibitor primitives relate a source activity to a target activity where the source and target activities are different. The inhibitor primitive creates an inhibitor dependency that prevents the target activity from starting after the sourcing activity has started.

In the example depicted in FIG. 2A, a portion of a workflow process includes a dependency between an activity A (block 204) and an activity B (block 206), which both succeed the precedent activity S (block 102). The precedence of activity S is indicated by two transitions 201 pointing to activity A and B respectively. To implement a requirement that either activity A or activity B is to be performed, but not both (exclusive inter-dependency), two inhibitor dependencies 200a and 200b (generically or collectively referred to as inhibitor dependency(ies) 200) are used. The first inhibitor dependency 200a between activity A and activity B prevents activity B from starting once activity A has started. The second inhibitor dependency 200b between activity B and activity A prevents activity A from starting once activity B has started.

In the depicted example, activities A and B are enabled once activity S has been performed. A decision is then made whether to perform activity A or B after S completes. The decision when to start activity A or activity B after activity S completes is typically made by the participant assigned to them after their roles are resolved. Once a selection is made and the selected activity started, the appropriate inhibitor dependency 200 is activated thereby inhibiting instantiation of the other activity. This run time behavior is illustrated in FIG. 2B.

If an activity has started, any inhibitor dependency targeting that activity has no effect. An activity may have multiple incoming inhibitors. If so, an inhibitor join policy can be attached to the activity to specify under what conditions the activity is to be inhibited. The join policy could be a simple AND condition where all of the inhibitors must be activated to inhibit the target activity, an OR condition in which case any of the inhibitors being active disables the target activity, or some other designer defined join policy. Like conventional control flow transitions, inhibitors may be constrained by an inhibiting condition.

To explain this further, consider that activity A has an output parameter STATUS. The value of STATUS can be used in defining normal control flow transition conditions, such as a transition between A and another activity C (not depicted in FIG. 2A). For example, if the transition condition between A and C is set to IF STATUS=“ok”, C can start only if A completes its execution and the value of STATUS is “ok”. Similar transition conditions can be specified for inhibitors. For example, IF STATUS=“ok” may also be specified as the inhibiting condition between activities A and B. In this case, the effect of this inhibiting condition is that A will inhibit B only if the value of STATUS is “ok”.

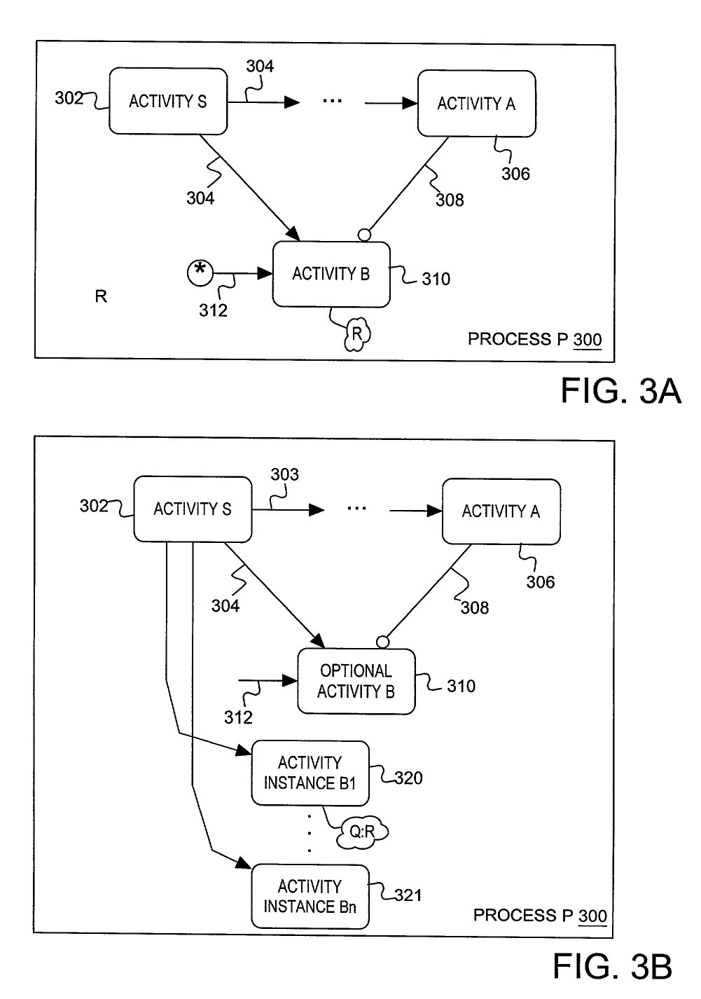

Turning now to FIGS. 3A and 3B conceptual illustrations of the option primitive 312 are depicted. FIG. 3A represents a portion of a process flow as contemplated at the time of specification (i.e., when the process workflow model is being developed) while FIG. 3B represents a run-time example of the portion of the same process flow. The option primitive 312 is a repeatable “creator” primitive because it permits an activity that is enabled by a normal control flow to be instantiated zero or more times. The time and number of instantiations may be determined by the participant assigned to the activity to which the option primitive is attached. Activities constrained by option dependencies cannot have outgoing dependencies to other activities in the process.

Although the option primitive and the inhibitor primitive are independent, they may be used to together to specify a window of opportunity. In the following paragraphs, the capability to define and execute a window of opportunity is described. If the inhibitors are removed from this discussion, the capabilities and use of the option primitive as a stand alone primitive are illustrated.

In FIG. 3A, an option primitive 312 is associated with activity B (block 310) during the specification of the process P. In addition, a role R is assigned to activity B. If an instance of P is executed, activity S (block 302) is performed first. After S completes, a control flow transition 304 originating at S evaluate to true assuming no transition conditions exist. Transitions 304 enables activity B, to which the optional primitive 312 is attached, as well another activity (not depicted) that immediately follows S and precedes A. When activity B is enabled, it becomes available to the members of role R (i.e., the users or applications who have been previously defined as playing the role) for execution and appears, therefore, in the work list of those associated with role R. Thus, the completion of Activity S and the enabling of activity B open a window of opportunity to perform Activity B. Notice also that an inhibitor dependency 308 exists between Activity A and Activity B.

In FIG. 3B, a participant Q, who is a member of R, opts to perform a first instance of Activity B by selecting B from his or her worklist. This causes the creation of a first instance of Activity B, indicated as Activity Instance B1 (block 320). Activity Instance B1 is assigned to Q and receives any input data previously specified for Activity B. Activity B itself stays on worklists of all players of role R. The remainder of the process proceeds independently of Activity Instance B1.

Additional instances of Activity B may be initiated by Q or other players of role R. One such additional instance is identified in FIG. 3B as Activity Instance Bn (block 321). The number of instances of activity B that may be initiated during the window of opportunity may be limited by a predetermined limit. This is specified in the option primitive and depicted by the star in a small circle in FIG. 3B. (The star indicates any number. If it is necessary to limit optional activities to 10, for example, the star is replaced by the limit number).

If Activity A is performed, the inhibitor primitive 308 is triggered thereby disabling Activity B, preventing additional instances of Activity B, and causing Activity B to disappear from the worklists of the role R participants. The performance of Activity A, therefore, closes the window of opportunity to perform activity B.

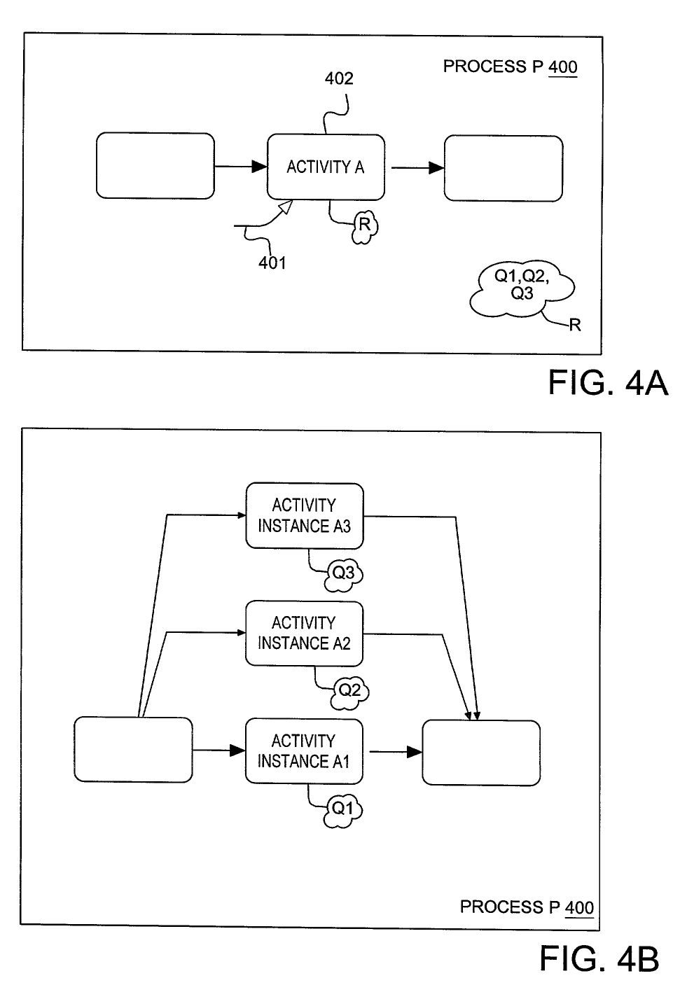

Turning now to FIGS. 4A and 4B, a group assignment primitive according to one embodiment of the present invention is depicted. In existing workflow technology, an activity in a process specification results in one and only one instance of the activity at runtime. Moreover, the instance is typically assigned to one and only one of the members of the role associated with the activity. This one-of-n role assignment may be suitable for applications in which work is distributed among a group of workers. In cooperative setting involving group activities that must be performed by multiple members of a group, however, the traditional one-of-n role assignment paradigm does not support assignment of activities to a group of participants at the same time.

The group assignment primitive according to the present invention defines an extension of the existing one-out-of-n participant assignment primitive to support group activities. Unlike the existing one-out-of-n role assignment primitive that produces one-to-one mapping of activity variables in the specification to activity instances at runtime, group assignment primitives may produce multiple activity instances from one activity variable. As one example, the group assignment primitive may result in M instances of an activity if M participants are assigned to the roles specified in an activity variable.

FIG. 4A illustrates a process P 400 that includes an activity A (block 402) to which an “all assignment” (i.e., m-of-m assignment) primitive 401 is associated. Activity A may be performed by players of the role R, which is assigned to Activity A as depicted. FIG. 4B illustrates the runtime of process P when activity A is assigned using an “all assignment” (i.e., m-of-m) role assignment. At runtime, the set of players of R is determined (Q1, Q2, and Q3 in this example). A different/separate instance of Activity A is then generated for each of the members of R. All instances of Activity A may be executed concurrently. In addition, all input data and all incoming control and data flow dependencies of Activity A get replicated for each instance of the activity.

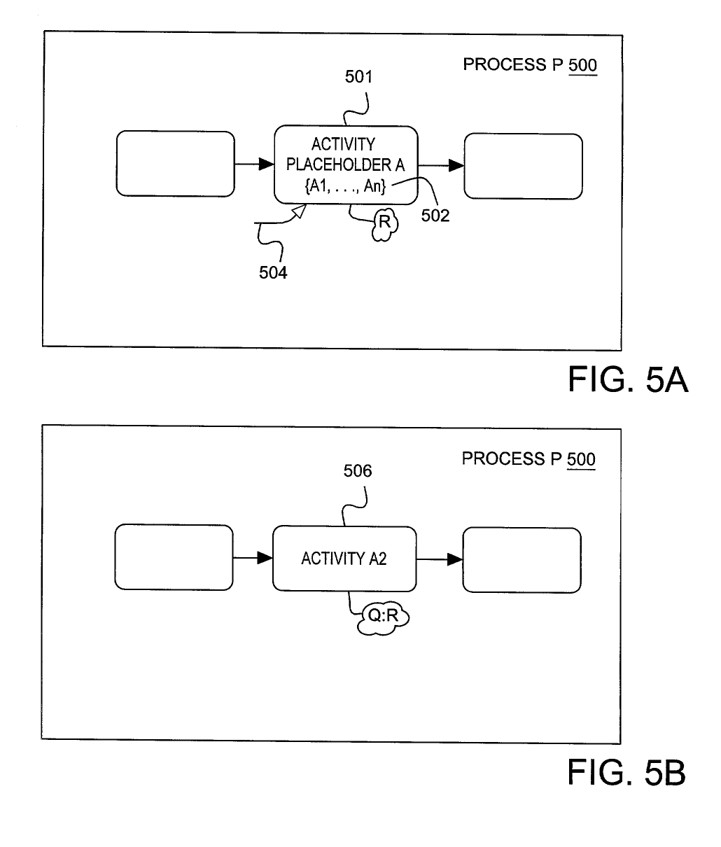

Turning now to FIG. 5A, an embodiment of an activity placeholder or abstract activity 501 according to one embodiment of the invention is depicted. An activity placeholder is a novel abstract activity type that enables the specification of activities whose concrete types and/or implementation may be unknown at the time a process 500 is specified. An activity placeholder may be declared at any point in a process specification where an activity could be declared. Activity placeholders may be replaced at runtime by specific activities.

Activity placeholder 501 may include a resolution policy 504. Activity placeholder 501 is similar to any other activity variable in a process, but its type is left unspecified at process specification time. At runtime, resolution policy 504 of activity placeholder 501 determines a specific activity type 502 from an available pool of specified activity types to be substituted for placeholder activity 501. Resolution policy 504 is specified to ensure syntactic and semantic compatibility between the placeholder and the activity type that eventually replaces it.

Resolution policy 504 may be implemented as a selection policy or a construction policy. A selection policy ensures syntactic (i.e., signature) and semantic compatibility by providing means for selecting appropriate replacement activities for the placeholder from a pool of activity types. Selection policies may range from the user making a simple choice from a menu of activity types to a full-blown process. A construction policy provides syntactic and semantic compatibility to the placeholder by creating the appropriate activity type to replace a placeholder. Construction policies are typically full-blown processes of themselves and provide the basis for late modeling. As an example, a placeholder primitive may include a construction policy when there is no existing activity type to replace a particular placeholder. When the placeholder is enabled, the construction policy starts a new process that defines the new activity type as needed.

In FIGS. 5A and 5B, a simple example of an activity placeholder with a process type P is depicted during specification and runtime respectively. The placeholder activity 501 has a role R assigned to it, and a selection resolution policy 504 that allows the participant selected from R at runtime to choose the actual activity 502 that will replace the placeholder from a list {A1, . . . , An}. To ensure semantic compatibility of the activity type that can be used as a replacement, the set of activity types from which a selection policy chooses is explicitly provided in the placeholder selection policy. During runtime, a player Q belonging to R is assigned to A when activity placeholder 501 is enabled. In this example, Q selects activity A2 from the menu of activity types presented to Q. Activity type A2 (block 506) is then substituted for activity placeholder 501 and a work item for A2 is placed on the worklist for Q. In this manner, the placeholder activity primitive gives the process developer great flexibility in defining activities and processes that may not be selected or defined during runtime.

What is claimed is:

1. A workflow management system comprising:
a process definition tool enabling a user to define a workflow process including an inhibitor primitive that defines a mutually exclusive interdependency between two activities in the process definition;
a workflow management engine configured to interpret the workflow process definition to perform workflow management tasks; and
a user interface enabling user access to the process definition tool.

2. The system of claim 1, wherein the process definition tool enables the user to define a workflow process including an option primitive that defines an activity that may be instantiated at least zero times during execution.

3. The system of claim 2, wherein the process definition tool enables the user to define a workflow process including a group assignment primitive that enables multiple role assignments to an activity resulting in multiple instances of the activity at runtime where each instance is associated with one of the corresponding role assignments.

4. The system of claim 3, wherein the process definition tool enables the user to define a workflow process including an abstract activity, wherein the activity type of the abstract activity is not defined until runtime.

5. A workflow management system comprising:
a process definition tool enabling a user to define a workflow process;
a workflow management engine configured to interpret the workflow process definition to perform workflow management tasks; and
a user interface enabling user access to the process definition tool;
wherein the definition tool and workflow management engine are configured to support primitives selected from the group of primitives consisting of an inhibitor primitive, an option primitive, a group assignment primitive, and an activity placeholder.
